(19) United States
(12) Patent Application Publication
(10) Pub. No.: US 2006/0143027 A1
(43) Pub. Date: Jun. 29, 2006

(54) Network usage analysis system using subscriber and pricing information to minimize customer churn and method

(76) Inventors: Srinivasan Jagannathan, Carpinteria, CA (US); Jorn Altmann, Berkeley, CA (US); Lee Rhodes, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/021,279

(22) Filed: Dec. 23, 2004

(51) Int. Cl. G06Q 99/00

(52) U.S. Cl. 705/1

(57) ABSTRACT

A network usage analysis system includes a data collector that is coupled to a network. The network has a first and a second network service provider and the first network service provider has a selected subscriber. The data collector collects usage data corresponding to a usage metric for the selected subscriber, an amount of data transferred for the selected subscriber, and a quality of service delivered for the selected subscriber. The system also includes a system server coupled to the data collector. The system server receives the usage data from the data collector and also receives pricing plan information for the first and second network service providers. The system server analyzes the pricing plan of the first network service provider based on the usage data collected and on the pricing plans of the first and second network service providers to determine the likelihood of customer churn.

### CROSS-REFERENCE TO RELATED APPLICATIONS

This application is related to the following concurrently filed U.S. patent application Ser. No. ______, Docket No. 200208403-1; Ser. No. ______, Docket No. 200208404-1; Ser. No. ______, Docket No. 200205880-1; and Ser. No. ______, Docket No. 200208406-1, all of which are incorporated herein by reference.

### BACKGROUND OF THE INVENTION

Network systems are utilized as communication links for everyday personal and business purposes. With the growth of network systems, particularly the Internet and wireless telephone networks, and the advancement of computer hardware and software technology, network use ranges from simple communication exchanges such as electronic mail to more complex and data intensive communication sessions such as web browsing, electronic commerce, and numerous other electronic network services such as Internet voice, and Internet video-on-demand.

Network usage information does not include the actual information exchanged in a communications session between parties, but rather includes metadata (data about data) information about the communication sessions and consists of numerous usage detail records (UDRs). The types of metadata included in each UDR will vary by the type of service and network involved, but will often contain detailed pertinent information about a particular event or communications session between parties such as the session start time and stop time, source or originator of the session, destination of the session, responsible party for accounting purposes, type of data transferred, amount of data transferred, quality of service delivered, etc. In telephony networks, the UDRs that make up the usage information are referred to as a call detail records or CDRs. In Internet networks, usage detail records do not yet have a standardized name, but in this application they will be referred to as internet detail records or IDRs. Although the term IDR is specifically used throughout this application in an Internet example context, the term IDR is defined to represent a UDR of any network.

Network usage information is useful for many important business functions such as subscriber billing, marketing and customer care, and operations management. Network usage data reporting systems are utilized for collecting, correlating, and aggregating network usage information as it occurs and creating UDRs as output that can be consumed by computer business systems that support the above business functions. Examples of these computer business systems include billing systems, marketing and customer relationship management systems, customer churn analysis systems, and data mining systems.

Especially for Internet networks, several important technological changes are key drivers in creating increasing demand for timely and cost-effective analysis of Internet usage information or the underlying IDRs.

One technological change is the dramatically increasing Internet access bandwidth at moderate subscriber cost. Most consumers today have only limited access bandwidth to the Internet via an analog telephony modem, which has a practical data transfer rate upper limit of about 56 thousand bits per second. When a network service provider's subscribers are limited to these slow rates there is an effective upper bound to potential congestion and overloading of the service provider's network. However, the increasing wide scale deployments of broadband Internet access through digital cable modems, digital subscriber line, microwave, and satellite services are increasing the Internet access bandwidth by several orders of magnitude. As such, this higher access bandwidth significantly increases the potential for network congestion and bandwidth abuse by heavy users. With this much higher bandwidth available, the usage difference between a heavy user and light user can be quite large.

Another technological change is the rapid growth of applications and services that require high bandwidth. Examples include Internet telephony, video-on-demand, and complex multiplayer multimedia games. These types of services increase the duration of time that a user is connected to the network as well as requiring significantly more bandwidth to be supplied by the service provider.

Another technological change is the transition of the Internet and other networks from “best effort” to “mission critical”. As many businesses are moving to the Internet, they are increasingly relying on this medium for their daily success. This transitions the Internet from a casual, best-effort delivery service into the mainstream of commerce. Business managers will need to have quality of service guarantees from their service provider and will be willing to pay for these higher quality services.

Network usage analysis systems provide information about how the service provider's services are being used and by whom. This is vital business information that a service provider must have in order to identify fast moving trends, establish competitive prices, and define new services or subscriber class as needed.

For reasons stated above and for other reasons presented in greater detail in the Description of the Preferred Embodiment section of the present specification, more advanced techniques are required in order to more compactly represent key usage information and provide for more timely extraction of the relevant business information from this usage information.

### SUMMARY OF THE INVENTION

The present invention is a network usage analysis system. The system includes a data collector that is coupled to a network. The network has a first and a second network service provider and the first network service provider has a selected subscriber. The data collector collects usage data corresponding to a usage metric for the selected subscriber, an amount of data transferred for the selected subscriber, and a quality of service delivered for the selected subscriber. The system also includes a system server coupled to the data collector. The system server receives the usage data from the data collector and also receives pricing plan information for the first and second network service providers. The system server analyzes the pricing plan of the first network service provider based on the usage data collected and on the pricing plans of the first and second network service providers to determine the likelihood of customer churn.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram of a network usage analysis system according to the present invention providing representation of network usage information and interactive usage analysis.

FIG. 2 is an exemplary embodiment block diagram of a network usage analysis system according to the present invention providing representation of network usage information and interactive usage analysis.

FIG. 3 is a flow diagram illustrating one exemplary embodiment of a method for analyzing network usage using customer information according to the present invention.

FIG. 4 is a block diagram of an alternative embodiment a network usage analysis system according to the present invention providing representation of network usage information and interactive usage analysis.

FIG. 5 is a flow diagram illustrating one exemplary embodiment of a method for analyzing network usage according to the present invention including providing direct statistical representation of usage information, compact storage and real time interactive usage analysis.

### DESCRIPTION OF THE PREFERRED EMBODIMENTS

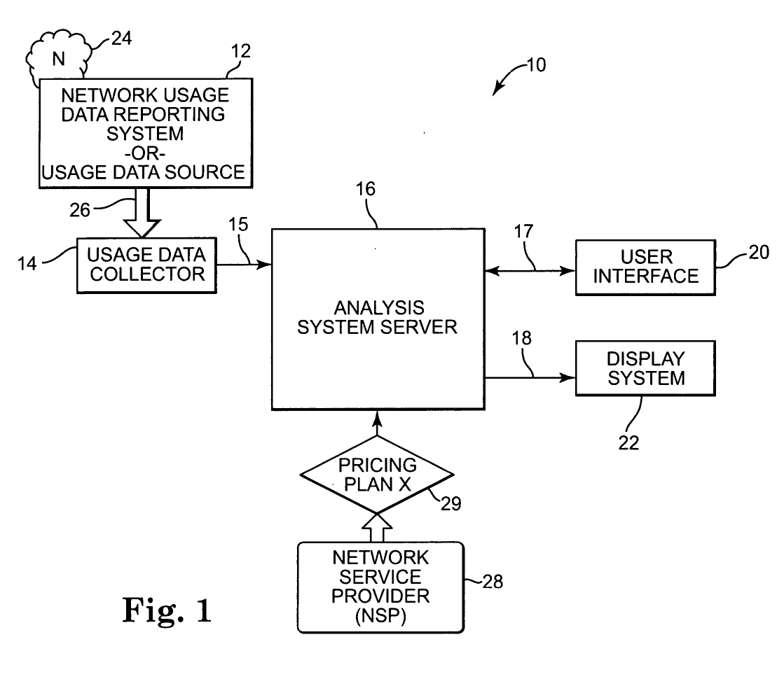

A network usage analysis system according to the present invention is illustrated generally at 10 in FIG. 1. Network usage analysis system 10 includes several main components, each of which comprises a software program. The main software program components of network usage analysis system 10 run on one or more computer or server systems. In one embodiment, each of the main software program components runs on its own computer system.

In one exemplary embodiment, network usage analysis system 10 includes a usage data collector 14, and a usage data analysis system server 16. Usage data collector 14 is coupled to usage data analysis system server 16 via communication link 15. Network usage analysis system 10 further includes user interface 20 and display system 22. User interface 20 and display system 22 are coupled to usage data analysis system server 16 via communication links 17 and 18, respectively.

Usage data collector 14 collects usage data 26. In one embodiment, the usage data 26 is a real time stream of IDRs generated from a usage data source or a network usage data reporting system 12, positioned on a network 24 (also indicated by an “N”). As used herein, a network usage data reporting system 12 is one type of usage data source. Alternatively, the IDRs may be received from a database or central data warehouse.

Usage data analysis system server 16 receives the usage data from usage data collector 14 via communication link 15. In one aspect, usage data collector 14 is separate from network usage data reporting system 12, and in another aspect, usage data collector 14 is part of a network usage data reporting system, such that the usage data analysis system server 16 receives the set of usage data directly from the network usage data reporting system. In another aspect, usage data collector 14 is part of the usage data analysis system server 16. Network 24 may be a plurality of server and host computer networks, such as the Internet, or may be a plurality of wireless networks, such as a cellular phone system.

Usage analysis system 10 is used in association with networks, such as such as the Internet or a wireless phone system. Usage data source 12 receives usage data 26 and passes usage data 26 to usage data collector 14. Usage data analysis system server 16 then receives and uses usage data 26 to perform analysis on the usage data 26. In addition to the type of service and network involved, information about a particular event or communications session between parties such as the session start time and stop time, source or originator of the session, destination of the session, responsible party for accounting purposes, type of data transferred, a usage metric (e.g., bandwidth, megabytes, time), amount of data transferred, quality of service delivered, the usage data 26 in the present invention also includes information about the pricing plan to which the particular subscriber of the network service provider subscribes.

Access to network 24 is provided and administered by network service providers, such as network service provider (NSP) 28. A variety of network service providers provide access to the network for end users, also referred to as subscribers or customers, and the network service providers maintain network 24 and access to network 24. In exchange for this service, network service providers charge the end user using a variety of prices and pricing plans designed to be attractive to the end user, but also generating revenue sufficient to maintain network access. NSP 28 has a pricing plan 29 that controls that fees that are charges to customers for access to network 24.

A variety of pricing plans are used by network service providers. Generally, these pricing plans can be separated into three categories: 1) flat-rate pricing plans, 2) connect-time-based pricing plans, and 3) use-based pricing plans. Historically, the first two pricing plans, flat-rate and connect-time pricing plans were more commonly used for network access, but are growing more out of favor because it is difficult to tailor the end user's actual use to the fees paid with these type of plans. If a flat fee is charged, those with low usage may be priced out of the service by the fees that would be required. If a connect-time-based plan is used, light-end users may be discouraged from exploring new internet media and curb growth. With a use-based plan, however, the particular fees paid by end users can be more closely tailored to actual use and quality of service demanded. Subscribers that are light users will be charged lower fees and those that are heavy users and demand high quality of service will be charged higher fees.

Usage-based pricing can also vary the fees paid by the consumer based on the end user's selection of various services. For example, a subscriber could choose a high bandwidth to be available to it such that it can expect higher performance in its network access. The user would pay an additional amount for this higher performance. Similarly, a user may also select that a higher priority level be available to it. In this way, when a network experiences high traffic, a user selecting a higher priority level will get priority and experience faster access to the network. Accordingly, the user will have to pay a higher amount for such higher priority level. Finally, a fee a user pays will also typically depend on the amount of data volume that a user sends and receives to and from the network over a particular to time. The higher volume of data generate by the user, the higher the fee will be charged by the network service provider.

When a network service provider provides network access with a usage-based pricing plan, the customers of the network service provider can be divided into segments. Those customers choosing peak bandwidth, high priority, and large amounts of volume of data, will be in a different customer segment, and pay a higher fee, than those choosing non-peak bandwidth, lower priority and lower volume of data. A network service provider may define multiple levels of customer segments and accordingly assign a corresponding fee for each customer segment.

In one embodiment, usage analysis system 10 collects and analyzes usage data 26, which includes information on the bandwidth, priority level, and amount of data volume used by customers, as well as information on the customer segment to which a particular customer belongs. Furthermore, NSP 28 has a particular pricing plan 29 for its customers, and this pricing plan 29 is provided to analysis system server 16. Analysis system server 16 receives and analyzes usage data 26 and pricing plan 29 to perform analysis that can be analyzed and displayed using user interface 20 and display system 22. With this data, analysis system server can be used to analyze customer usage under pricing plan 29 and determine the applicable fees to customers in various customer segments.

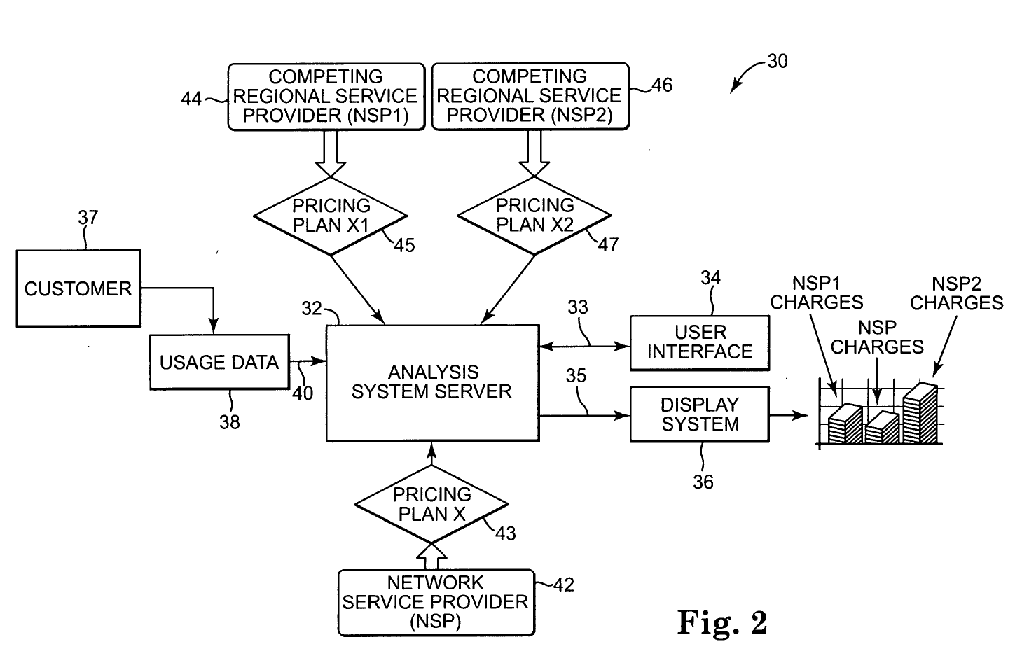

A network usage analysis system according to the present invention is illustrated generally at 30 in FIG. 2. Network usage analysis system 30 includes several main components, each of which is a software program. The main software program components of network usage analysis system 30 run on one or more computer or server systems. In one embodiment, each of the main software program components runs on its own computer system.

In one exemplary embodiment, network usage analysis system 30 includes an analysis system server 32, user interface 34, and display system 36. User interface 34 and display system 36 are coupled to analysis system server 32 via communication links 33 and 35, respectively. Usage data 38 collected from a network is received by system server 32 via communication link 40. Usage data 38 includes the type of service and network involved, information about a particular event or communications session between parties such as the session start time and stop time, source or originator of the session, destination of the session, responsible party for accounting purposes, type of data transferred, a usage metric (e.g., bandwidth, megabytes, time), amount of data transferred, quality of service delivered, information about the pricing plan to which the particular subscriber of the network service provider subscribes, including the bandwidth, priority level, amount of data volume used by customers, as well as the customer segment to which a particular customer belongs.

In addition, analysis system server 32 receives information regarding the pricing plans of various network service providers. In one embodiment, a main network service provider 42 has a pricing plan 43 that is received by analysis system server 32. Furthermore, main network service provider 42 competes with other regional service providers. Competing regional service providers 44 and 46 each have their own pricing plans 45 and 47, respectively. These pricing plans 45 and 47 are received by analysis system server 32, along with the pricing plan 43 for main NSP 42.

In one embodiment, usage analysis system 30 is used to make business decisions about a network, and subscribers to the network, based on an analysis of usage data 38 and the pricing plans 43, 45, and 47. The usage data 38 is reflective of a selected customer 37 of NSP 42. The usage data 38 can be correlated for the selected customer 37 to create a customer profile such that the charges incurred for the selected customer 37 of NSP 42 under pricing plan 43 can be calculated. In one embodiment, the customer profile will include the usage metric, amount of data transferred, quality of service delivered, and the customer segment to which the selected subscriber of the network service provider belongs. Then, using the pricing plan information 45 and 47 from competing NSPs 44 and 46, the same customer profile, can be used to calculate what the charges would be for the selected customer 37 if it were using the pricing plan 45 and 47 of competing NSPs 44 and 46. The calculated charges for the main NSP 42 can be compared to the calculated charges for the competing NSPs 44 and 46. In this way, a determination can be made about how likely it is that the selected customer 37 will migrate to a competing NSP.

For example, a selected customer 37 for analysis may have usage data collected to generate a data usage profile for the customer 37. This data usage profile for this selected customer 37 can be used to calculate the fees charged using pricing plans 43, 45 and 47. This will indicate what this selected customer 37 is currently being charged under the main NSP's 42 pricing plan 43, as well as what it would be charged under competitor NSPs' 44 and 46 pricing plans 45 and 47. If the analysis shows that the main NSP 42 has the best price, then the selected customer 37 can be expected to be loyal to the main NSP 42 and not change to another. The main NSP 42 can even choose to advertise in some way to the customer to inform the customer that it is getting a better value with the main NSP 42 than it would have with competitors.

If, on the other hand, the main NSP 42 price is higher than the competitor NSPs 44 and 46, then there is a high likelihood that the selected customer 37 will discontinue that service with the main NSP 42. In this case, a marketing team, or similar resource, can perform further analysis to investigate whether there is a way to retain the selected customer 37. For example, if the selected customer 37 belongs to a customer segment that pays more for choosing peak bandwidth, high priority, and capacity for large volumes of data, but its data usage profile indicates that the selected customer 37 is not taking full advantage of the resources available to that customer segment, it could be recommended to the selected customer 37 that it switch to a lower customer segment. In this way, it would still achieve efficient access to the network, yet do so at a reduced cost. By offering services at a reduced cost, the main NSP 42 may retain the selected customer 37.

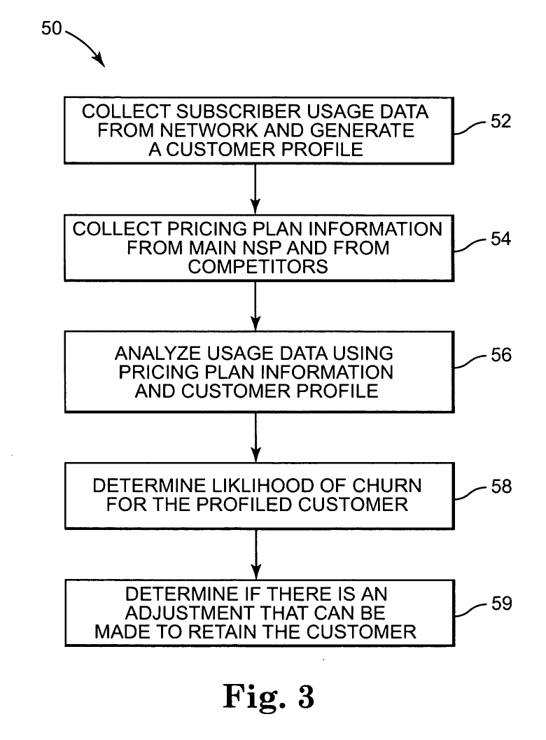

In FIG. 3, a flow diagram illustrating one exemplary embodiment of a method for analyzing network usage according to the present invention is illustrated generally at 50. Reference is also made to FIGS. 1 and 2. In step 52, usage data is collected from the network for analysis. The type of usage data collected is that which can be generated from a network usage data reporting system or a usage data source 12. In one exemplary embodiment, the usage data 26 consists of a real time or real time stream of IDRs received from a network usage data reporting system. The usage data collector 14 collects usage data from the IDRs that may include the type of service and network involved, information about a particular event or communications session between parties such as the session start time and stop time, source or originator of the session, destination of the session, responsible party for accounting purposes, type of data transferred, a usage metric (e.g., bandwidth, megabytes, time), amount of data transferred, quality of service delivered, information about the pricing plan to which the particular subscriber of the network service provider subscribes, including the bandwidth, priority level, amount of data volume used by customers, as well as the customer segment to which a particular customer belongs. This usage data is used to generate a usage profile for a selected customer.

In step 54, price plan information is obtained from network service providers. In addition to the price plan of the main network service provider that is producing and collecting the usage data, a price plan for at least one of its competitors is also obtained.

In step 56, the collected usage data 38 is analyzed along with the pricing plans. The analysis includes the use of the data usage profile for the selected customer in view of the pricing plans. For the data usage profile for the selected customer, the charges incurred by that selected customer 37 under the main network service provider's pricing plan is calculated, as are the charges incurred by that selected customer under the competitor's pricing plan.

In step 58, the likelihood of customer churn is determined based on the charges incurred by the selected customer under the price plan of the main network service provider as compared to the pricing plans of its competitors, which were calculated in the previous step. If the charges incurred by the selected customer under the competitor's pricing plan are more than the charges incurred by under the main network service provider's pricing plan, then there is little reason to expect that the selected customer will move to the competitors and the this risk of customer churn is low. If the charges incurred by the selected customer under the competitor's pricing plan are less than the charges incurred by that segment under the main network service provider's pricing plan, however, then it is likely that the customer will move to a competitor, and the likelihood of customer churn is high.

In step 59 a business decision is made based on the determination of the likelihood of customer churn. For example, if it is determined that the likelihood of churn is low, that is, the selected customer pays less under the pricing plan of the main network service provider than under the pricing plan of any of the competitors, then no action needs to be taken. The main network service provider may advertise this fact, however, to its selected customer in order to derive good will from the fact that it is giving the customer the best value.

If it is determined that the likelihood of churn is high, that is, the selected customer pays more under the pricing plan of the main network service provider than under the pricing plan of any of the competitors, then some action must be taken by the main network service provider in order to reduce the risk of customer churn. For example, the usage profile for the selected customer can be further examined to determine whether the customer can move to a different customer segment, and thus different cost structure, such that the customer will no longer pay more under the main network service provider compared to its competitors. Accordingly, usage analysis system 10 accomplishes designing of pricing plans to reduce customer chum and sustain customer loyalty.

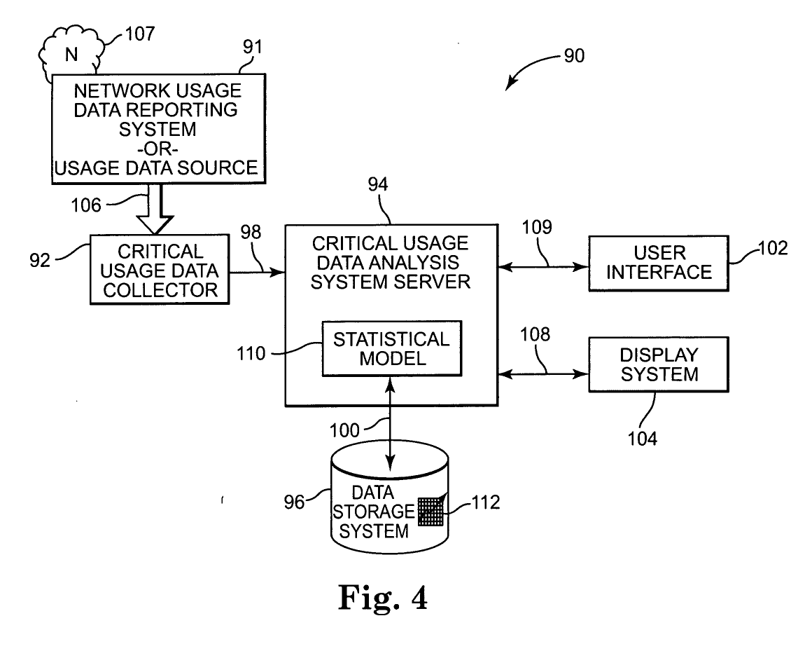

In another embodiment of the present invention, illustrated in FIG. 4, network usage analysis system 90 provides direct statistical representation of usage information and provides compact storage and real time, interactive usage analysis. The network usage analysis system 90 in accordance with the present invention provides for the use of statistical models and the storage of statistical data representative of critical usage data in lieu of storing the critical usage data, thereby allowing for real time interactive statistical analysis and greatly reducing usage data storage requirements. Since statistical models are stored and not the usage data itself, with the present invention the storage requirements do not grow with the amount of usage data. The storage requirements for the statistical models are a function of the complexity of the business to be modeled and the granularity of the desired results.

In one exemplary embodiment, network usage analysis system 90 includes a critical usage data collector 92, a critical usage data analysis system server 94 and a data storage system 96. Critical usage data collector 92 is coupled to critical usage data analysis system server 94 via communication link 98. Data storage system 96 is coupled to critical usage data analysis system server 94 via communication link 100. Network usage analysis system 90 further includes user interface 102 and display system 104. User interface 102 and display system 104 are coupled to critical usage data analysis system server 94 via communication links 109 and 108 respectively.

Critical usage data collector 92 collects critical usage data (e.g., a set of critical usage data) from usage data 106. Preferably, the usage data 106 is a real time stream of network usage data records. In one embodiment, the usage data 106 is a real time stream of IDRs generated from a usage data source or a network usage data reporting system 91, positioned on a network 107 (also indicated by an “N”). As used herein, a network usage data reporting system 90 is one type of usage data source. Alternatively, the IDRs may be received from a database or central data warehouse.

One network usage data reporting system suitable for use with the present invention is commercially available under the tradename SMART INTERNET USAGE 2.01 (SIU 2.01), from Hewlett-Packard, U.S.A. Other network usage data reporting systems suitable for use with the usage analysis system in accordance with the present invention will become apparent to those skilled in the art after reading the present application.

Usage data analysis system server 94 receives the critical usage data from the critical usage data collector 92 via communication link 98. In one aspect, the critical usage data collector 92 is separate from a network usage data reporting system, and in another aspect, the critical usage data collector 92 is part of a network usage data reporting system, such that the critical usage data analysis system server 94 receives the set of critical usage data directly from the network usage data reporting system. In another aspect, the critical usage data collector 92 is part of the critical usage data analysis system server 94.

The critical usage data analysis system server 94 uses the set of critical usage data to perform predetermined network usage statistical analysis. In particular, a statistical model 110 is defined for the business problem of analyzing pricing plans of network service providers in view of selected customer usage profiles in order to reduce customer churn. The critical usage data analysis system server 94 uses the critical usage data and the statistical model 110 to generate statistical data 112. The critical usage data analysis system server 94 operates to store the statistical data 112 in the data storage system 96. In one aspect, the statistical data is stored in the form of a table (e.g., a distribution table

After storage of the statistical model 110, the set of critical usage data is no longer retained. In one aspect, the critical usage data analysis system server 94 is responsive to the user interface 102 for interactive analysis of the statistical model 110. Further, a graphical display of the statistical model 110 can be output to display system 104. One exemplary embodiment of interactive analysis of critical usage data using the statistical model 110 is described in related application INTERNET USAGE ANALYSIS SYSTEM AND METHOD, Ser. No. 09/548,124, filed Apr. 12, 2000, which is incorporated by reference herein.

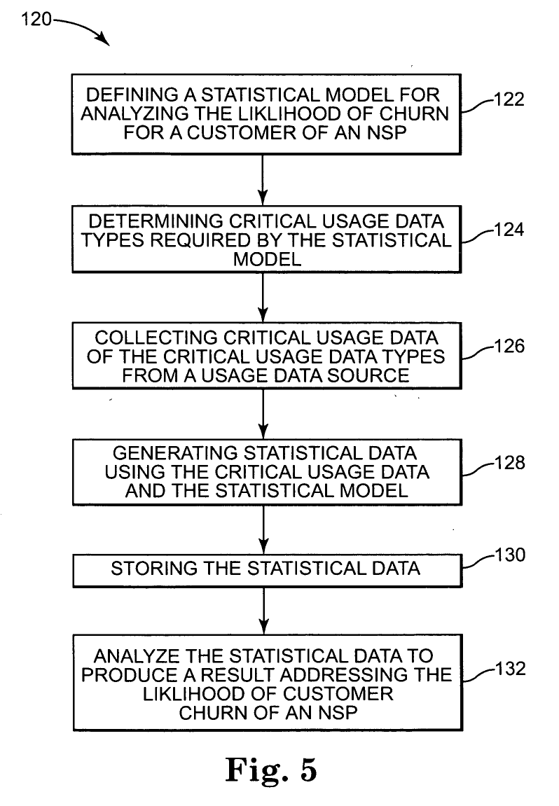

In FIG. 5, a flow diagram illustrating one exemplary embodiment of a method for analyzing pricing plans for network subscribers according to the present invention is illustrated generally at 120. Reference is also made to FIG. 4. In step 122, a statistical model is defined for solving a business problem of reducing customer churn by analyzing the pricing plan of a main network service provider and those of its competitors in view of collected usage data for a selected customer.

In step 124, critical usage data types required by the statistical model are determined. The type of statistical model chosen is based on the network usage related business problem of reducing customer churn for a network service provider based on collected usage data. By defining only critical usage data types required by the statistical model, the volume of usage data that needs to be collected is greatly reduced. For example, the critical usage data may be information about the usage metric (e.g., bandwidth, megabytes, time), amount of data transferred, quality of service delivered, information about the pricing plan to which the particular subscriber of the network service provider subscribes.

In step 126, critical usage data 98 of the critical usage data types are collected from usage data 106 that can be generated from a network usage data reporting system or a usage data source 91. In one exemplary embodiment, the usage data 106 consists of a real time or real time stream of IDRs received from a network usage data reporting system. A real time stream of IDRs is defined as a stream of IDRs that is “flushed” or transferred from a data storage location at regular and frequent intervals (e.g., which may be substantially instantaneous or, based on the usage data source, from seconds to minutes). The critical usage data collector 92 collects critical usage data from the IDRs that may be the usage metric (e.g., bandwidth, megabytes, time), the amount of data transferred, the quality of service delivered, information about the pricing plan to which the particular subscriber of the network service provider subscribes, including the bandwidth, priority level, amount of data volume used by customers, as well as the customer segment to which a particular customer belongs.

In step 128, statistical data representative of the critical usage data are generated. In particular, statistical data are generated using the critical usage data and the statistical model. The step of generating the statistical data can be done in real time.

In step 130, the statistical data are stored. The statistical data may be stored in various forms, such as in the form of a table or graph in volatile or nonvolatile memory. After storing of the statistical data, the critical usage data can be deleted, since it is not necessary to retain it for the selected network usage related business problem. As such, storing of the statistical data representative of the collected critical usage data in lieu of storing the critical usage data itself greatly reduces data storage requirements.

In step 132, the statistical data can be analyzed to produce a result addressing the network usage related business problem of reducing customer chum by analyzing pricing plans of network service providers based on collected usage data. Also, the statistical data may be stored in volatile memory (e.g., RAM) to provide for interactive analysis and presentation of results pertinent to the network usage related business problem. The statistical data may be stored and/or archived in non-volatile memory, such as a hard disk drive. In particular, the statistical model is used to determine/analyze usage characteristics. The statistical model may also be used for performing interactive analysis of the critical usage data via user interface 102. In particular, the statistical model may include one or more variable elements, wherein the variable elements are changeable via user interface 102 to interactively model network usage. The statistical model results can be graphically or otherwise displayed using display system 104.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method for analyzing network subscriber usage comprising the steps of:
collecting network subscriber usage data from a network;
selecting a subscriber from a first network service provider;
generating a subscriber profile from the collected subscriber usage data for the selected subscriber of the first network service provider;
collecting pricing plan information from the first network service provider;
collecting pricing plan information from a second network service provider;
calculating actual charges for the selected subscriber, using the subscriber profile, under the pricing plan information from the first network service provider;
calculating projected charges for the selected subscriber, using the subscriber profile, under the pricing plan information from the second first network service provider; and
analyzing the subscriber profile and the actual and projected charges in order to make a determination involving whether the selected customer is likely to move from the first network service provider to the second network service provider.

2. The method of claim 1, further comprising generating statistical data from the collected subscriber usage data using a statistical model comprising at least one of a histogram, an ordered histogram, a probability density function and a cumulative probability distribution function and analyzing the pricing plans of the first and second network service providers from the generated statistical data.

3. The method of claim 2, further comprising storing only the statistical data.

4. The method of claim 1, wherein the subscriber profile corresponds to a usage metric, amount of data transferred, and quality of service delivered for the selected subscriber.

5. The method of claim 1, further comprising collecting pricing plan information from a third network service provider.

6. The method of claim 5, further comprising calculating third charges for the selected subscriber, using the subscriber profile, under the pricing plan information from the third network service provider and analyzing the subscriber profile and the first, second and third charges in order to make a determination involving whether the selected customer is likely to move from the first network service provider to the second or third network service providers.

7. The method of claim 1, wherein when the actual charges are more than the projected charges, it is determined that likelihood of customer churn is high and the first network service provider takes measures to reduce the likelihood of customer chum.

8. The method of claim 7, wherein the pricing plan information from the first and second network service providers includes customer segments and wherein a determination is made as to which customer segment the selected subscriber belongs for the pricing plan information from the first and second network service providers.

9. The method of claim 8, wherein the measures taken to reduce customer chum include changing the customer segment to which the selected subscriber belongs to reduce the costs the subscriber pays under the pricing plan for the first network service provider.

10. The method of claim 8, wherein a recommendation is made to the selected subscriber to change customer segments in order to reduce customer churn.

11. The method of claim 1, wherein analyzing a network comprises analyzing a network as an Internet network.

12. The method of claim 1, wherein analyzing a network comprises analyzing a network as a wireless telephone network.

13. A network usage analysis system comprising:
a data collector coupled to a network having a first and second network service providers, the first network service provider having a selected subscriber, wherein the data collector collects usage data corresponding to a subscriber profile for the selected subscriber, the subscriber profile corresponding to a usage metric for the selected subscriber, an amount of data transferred for the selected subscriber, and a quality of service delivered for the selected subscriber; and
a system server coupled to the data collector, wherein system server receives the usage data from the data collector and further receives pricing plan information for the first and second network service providers, and wherein the system server analyzes the pricing plan of the first network service provider based on the usage data collected and on the pricing plans of the first and second network service providers to determine the likelihood of customer churn.

14. The system of claim 13, wherein the system server generates statistical data based on the usage data and on a predefined statistical model comprising at least one of a histogram, an ordered histogram, a probability density function and a cumulative probability distribution function and the system server analyzes the pricing plan of the first network service provider from the generated statistical data.

15. The system of claim 14, further comprising a data storage system for storing only the statistical data.

16. The system of claim 14, wherein the system server updates the statistical data using additionally collected usage data.

17. The system of claim 15, wherein the data storage system includes random access memory.

18. The system of claim 15, wherein the data storage system includes a hard disk drive or other persistent storage device.

19. The system of claim 14, further comprising a user interface operably coupled to the system server.

20. The system of claim 19, wherein the system server is responsive to the user interface for interactive analysis of the statistical model.

21. The system of claim 14, further comprising a display system for displaying the statistical model.

22. The system of claim 14, wherein the statistical model is in the form of a table.

23. The system of claim 14, wherein the table is a distribution table.

24. The system of claim 13, wherein the network is an Internet network.

25. The system of claim 13, wherein the network is a wireless telephone network.

26. A method for analyzing network subscriber usage, including reducing the churn of subscribers from a main network service provider, the method comprising the steps of:
collecting network subscriber usage data from the network to generate a customer profile for a selected subscriber;
collecting pricing plan information from the main network service provider;
collecting pricing plan information from a second network service provider;
analyzing the customer profile using the pricing plan information from both the main and the second network service providers; and
adjusting the pricing plan of the main network service provider when the analysis of the customer profile indicates that the main network service provider is charging the selected subscriber more than the second network service provider.

27. The method of claim 26, further comprising generating statistical data from the collected subscriber usage data using a statistical model comprising at least one of a histogram, an ordered histogram, a probability density function and a cumulative probability distribution function and adjusting the pricing plan of the first network service provider based on the generated statistical data.

28. The method of claim 27, further comprising storing only the statistical data.

29. The method of claim 28, further comprising collecting a second set of usage data and updating the statistical data using the second set of critical usage data.

30. The method of claim 28, further comprising deleting the usage data after storing the statistical data.

31. The method of claim 27, further comprising using the statistical model to perform interactive analysis of the usage data.

32. The method of claim 26, wherein analyzing a network comprises analyzing a network as an Internet network.

33. The method of claim 26, wherein analyzing a network comprises analyzing a network as a wireless telephone network.

34. A computer readable medium containing instructions for controlling a computer system to perform a method for reducing the churn of subscribers from a main network service provider comprising the steps of:
collecting network subscriber usage data from the network to generate a customer profile for a selected subscriber;
collecting pricing plan information from the main network service provider;
collecting pricing plan information from a second network service provider;
analyzing the customer profile using the pricing plan information from both the main and the second network service providers; and
adjusting the pricing plan of the main network service provider when the analysis of the customer profile indicates that the main network service provider is charging the selected subscriber more than the second network service provider.

35. The computer readable medium of claim 34, further comprising generating statistical data from the collected subscriber usage data using a statistical model comprising at least one of a histogram, an ordered histogram, a probability density function and a cumulative probability distribution function and adjusting the pricing plan of the first network service provider based on the generated statistical data.

36. The computer readable medium of claim 35, further comprising storing only the statistical data.
